(19) United States
(12) Patent Application Publication
(10) Pub. No.: US 2017/0030141 A1
(43) Pub. Date: Feb. 2, 2017

(54) Window Blind Clips and Method of Use

(71) Applicant: Robert Marion Cato, Fuquay Varina, NC (US)

(72) Inventor: Robert Marion Cato, Fuquay Varina, NC (US)

(21) Appl. No.: 15/211,226

(22) Filed: Jul. 15, 2016

Related U.S. Application Data
(60) Provisional application No. 62/198,088, filed on Jul. 28, 2015.

(51) Int. Cl. E06B 9/32; E06B 9/327; F16B 2/22; E06B 9/38

(52) U.S. Cl. CPC E06B 9/32; E06B 9/38; E06B 9/327; F16B 2/22

(57) ABSTRACT

Disclosed is a removably attachable clip for window blinds. The clip includes a middle section and a pair of arms extending from the middle section. The middle section includes an opening for sliding onto a window blind slat. Once secured on the window blind slat, ladder cords disposed on the blinds are guided through the clip so that ladder cords are positioned between the arms. The clip is configured to hold the ladder cords so as to secure the blinds below the clip in a closed configuration while leaving the blind above the clip in an open configuration.

### CROSS-REFERENCE TO RELATED APPLICATIONS

This application claims the benefit of U.S. Provisional Patent Application No. 62/198,088, filed Jul. 28, 2015, which is hereby incorporated by reference in its entirety.

### FIELD OF THE INVENTION

The present invention relates generally to window treatments. More particularly, the present invention is directed to a device that can be removably attached to window blind slats for positioning some of the blind slats closed while leaving others open.

### BACKGROUND OF THE INVENTION

Various types of window treatments, such as window blinds or curtains, for providing shade and privacy are known in the prior art. To open and close traditional blinds having horizontal slats, a user can lift the blinds from the bottom via a lift cord or rotate the blind slats to an open position or a closed position. These blinds generally work in unison such that all of the blind slats are manipulated in a simultaneous manner. Specifically, all of the slats rotate simultaneously into the open or the closed position. Similarly, the all of the multiple blind slats can be lifted or lowered via one or more lift cords.

While a user can partially lift the blind slats to keep the blinds open at the bottom and closed at the top, traditional window blinds are limited in that they do not allow a user to keep the bottom portion of the blinds closed while keeping the upper portion of the blinds open. This can be problematic particularly when the user wishes to let in light through the top of the window while maintaining some privacy.

Some devices have been disclosed in the prior art that provide shade or privacy on bottom half of windows. These include window panels that can be placed on windowsills and shades that are pulled upwards (i.e., from a bottom end of a window). The devices disclosed in the prior art have several known drawbacks, however. Most notably, these devices are limited in that they must be used in conjunction with existing blinds or in place of existing blinds. Therefore, users must install additional hardware, which can be time consuming and costly. In this regard, the invention described herein addresses this problem.

### SUMMARY OF THE INVENTION

In view of the disadvantages inherent in the known types of devices for window blinds now present in the prior art, the present invention provides an improved a clip for window blind slats, wherein the clip can be used for securing the blind slats in a desired position.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as to prelude to the more detailed description that is disclosed later.

In a preferred embodiment, the present invention comprises a clip that can be removably attached to window blinds. The clip substantially comprises an L-shape when viewed from the side, with a defined middle section and two arms extending perpendicularly therefrom, wherein the middle section comprises an opening for receiving a blind slat therethrough. The arms are substantially parallel to each other and separated by a space. The arms are configured to guide ladder cords disposed on the blinds on which it is attached.

In use, the arms keep the ladder cords below the clip closed while allowing the cords above the clip to stay open and close by the normal tilting function of the blinds. In this way, the blind slats above the clip remain open, or in a horizontal configuration, while the blind slats below the clip remain closed, or in a substantially vertical or tilted configuration. Such configurations do not prevent the user from raising or lowering the blind slats while the clip is in place, via lift cords. In this way, the present invention allows users to utilize existing blinds in a versatile manner.

It is therefore an objective of the present invention to provide a clip that can be removably secured onto a window blind slat for allowing some of the window blind slats to remain closed while allowing others to open and close freely.

It is another objective of the present invention to provide a clip for window blinds that can be retrofitted to various types of window blind slats.

It is still another objective of the present invention to provide temporary means of adjusting blind slats into desired positions.

It is still another objective of the present invention to provide a clip that does not interfere with the functionality of lift cords when secured to a blind slat, thereby allowing window blinds to raise and lower.

A final objective of the present invention to provide a clip for that may be readily fabricated from materials that permit relative economy and commensurate with durability.

In the light of the foregoing, these and other objects are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 is a perspective view of the present invention.

FIG. 2 is a close up view of the present invention in use.

FIG. 3 shows a side planar view of the present invention in use.

### DETAILED DESCRIPTION OF THE INVENTION

The present invention is directed towards clips that can be removably attached to window blind slats for positioning the same. For purposes of clarity, and not by way of limitation, illustrative views of the present clip are described with references made to the above-identified figures. Various modifications obvious to one skilled in the art are deemed to be within the spirit and scope of the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.”

Additionally, the articles “a” and “an” as used in this application and the appended claims should generally be construed to mean “one or more” or “at least one” unless specified otherwise or clear from context to be directed to a singular form. It is to be appreciated that determinations or inferences referenced throughout the subject specification can be practiced through the use of artificial intelligence techniques.

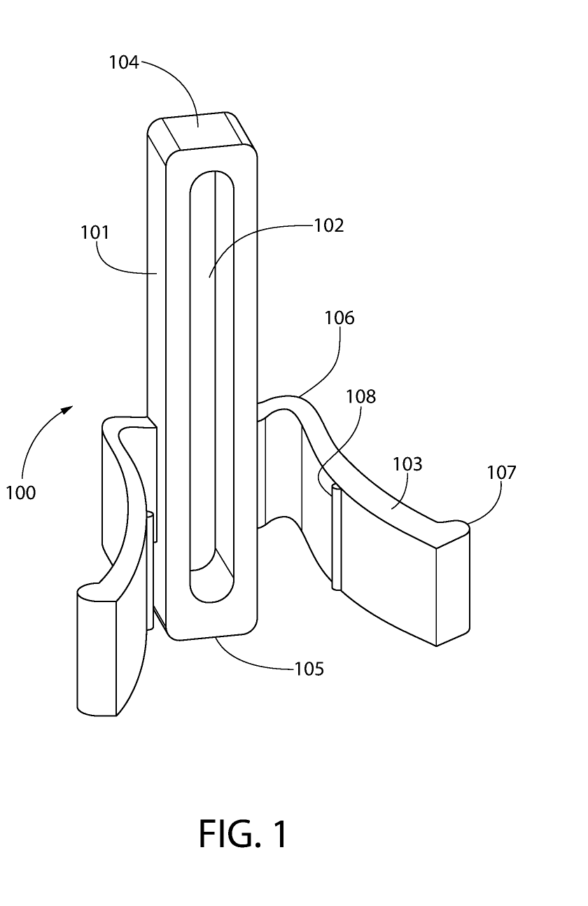

Referring now to FIG. 1, there is shown a perspective view of the present invention. The present invention comprises a clip 100, wherein the clip 100 comprises an elongated middle section 101 having a central opening 102, the central opening 102 elongated in shape. In the illustrated embodiment, the opening 102 substantially spans the length of the middle section 101. Preferably, the opening 102 is shaped and dimensioned to receive a single blind slat therethrough. The middle section 101 comprises a first end 104 opposite a second end 105.

The middle section 101 of the clip 100 comprises a pair of arms 103 extending therefrom. The arms 103 may be structurally integral to the middle section 101 so that the clip 100 is unitary in structure. Preferably, the arms 103 are biased toward the second end 105 of the middle section 101 such that the distance between the arms 103 and the second end 105 of the middle section 101 is less than the distance between the arms 103 and the first end 104 of the middle section 101. The arms 103 are substantially perpendicular to the middle section 101 such that when the clip 100 is viewed from the side, it is substantially L-shaped.

Each arm 103 comprises a first end 106 and a second end 107, wherein the first end 106 is attached to the middle section 101 of the clip 100. Additionally, the first end 106 comprises a bend so that each arm 103 is also L-shaped when viewed from the top, and the clip 100 is symmetrical. In other embodiments, however, it is contemplated that the arms 103 can comprise other shapes. For example, the arms 103 may be more curved so that it is more C-shaped or S-shape when viewed from the top. The second end 107 of the arms 103 curve or bow away from the middle section 101 and away from each other such that the distance between the arms 103 increase from the first end 106 to the second end 107.

Some embodiments of the arms 103 further comprise a protrusion 108, wherein the protrusion 108 face toward each other so that they are disposed on an inner surface of the arms 103. The protrusion 108 spans the width of the arms 103 so that it is slightly elongated. In the illustrated embodiment, the protrusion 108 is disposed at substantial midpoint of the arms 103. Alternatively, the protrusion 108 may be biased toward the first end 106 of the arms 103. The protrusions 108 are configured to secure ladder cords between the arms 103 when the clip 100 is secured on a blind slat.

In some embodiments, the clip 100 is composed of plastic or other suitable materials. It is noted that the material should have sufficient stiffness to hold its shape and remain secured onto blind slats.

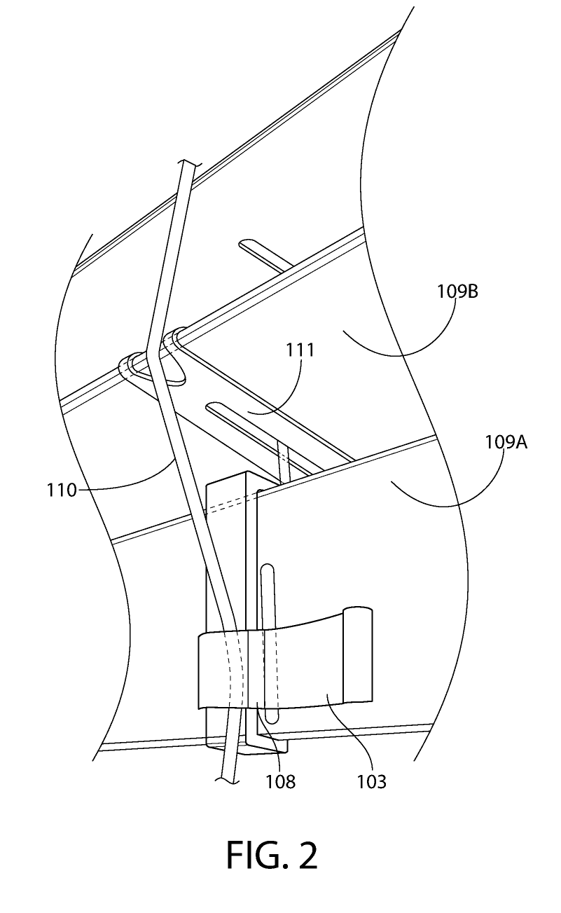

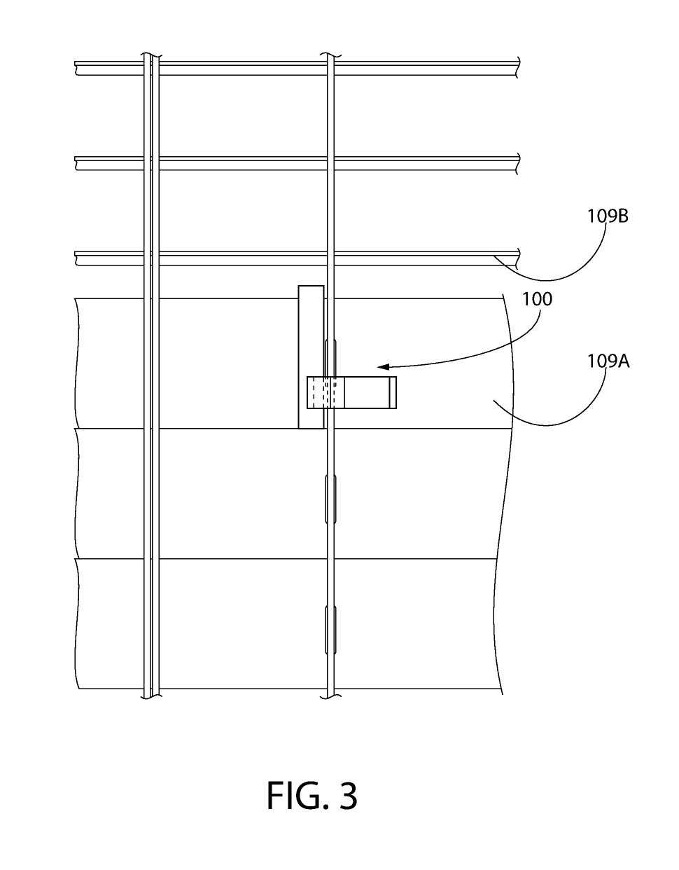

Referring now to FIGS. 2 and 3, there are shown a close up view and a side planar view of the present invention in use. In operation, the middle section of the clip 100 is slid onto a blind slat 109A. More particularly, the blind slat 109A is inserted through the elongated opening of the middle section so that one arm is placed on one side of the blind slat 109A and another arm is placed on the opposite side of the blind slat 109A. In this way, the arms substantially hug the blind slat 109A. Additionally, the clip 100 is oriented such that the arms are biased toward the bottom end of the blind slat 109A. In some embodiments, however, the arms may be located at substantial midpoint of the middle section of the clip.

The clip 100 is placed on a blind slat where a user wishes to keep the blinds therebelow in a closed configuration, while leaving the blinds thereabove in an open configuration. In this way, more or less blind slats can stay closed or opened depending on where the clip 100 is placed. In the illustrated embodiment, the blind slat 109A on which the clip 100 is placed and the slats therebelow remain closed, while the blind slats 109B above the blind slat 109A on which the clip 100 is attached can open and close so as to function normally.

The clip 100 is positioned on the blind slat 109A such that the ladder cords 110 are substantially aligned with the clip 100 and the ladder cords 110 can be guided through the clip 100. It is noted that the clip 100 does not need to pass the lift cord so that the blinds can be lifted and lowered freely while the clip 100 is in position. In this regard, the clip 100 is positioned short of a terminal end of the blind slat 109A. Preferably, one clip 100 is positioned near each end of the blind slat 109A such that two clips 100 are used.

A first ladder cord (i.e., a ladder cord facing the front of the blinds) is guided between a first side of the blind slat 109A and first arm; and a second ladder cord (i.e., a ladder cord facing the back of the blinds) is guided between a second side (i.e., opposite of the first side) of the blind slat 109A and the second arm. The curved configuration of the arms 103 enable a user to slightly lift the second end of the arms 103 away from the blind slats to adjust the ladder cords in place.

Once the ladder cords are guided through the clip 100, the protrusion 108 on the arms 103 prevent the ladder cords from escaping the clip 100. The arms 103 pinch the ladder cords 110 together at the second end (i.e., the bottom end) of the middle section 101 to keep the blind slats below the clip 100 in a closed configuration. In other embodiments, however, the shape of the arms 103 may prevent the ladder cords from escaping, eliminating the need for the protrusion 108.

Optionally, the clips 100 may be used in conjunction with a slat guide clip 111. The slat guide clip 111 is placed on the top-most slat of blinds to ensure that the rest of the slats move consistently together. The exact configuration and type of the slat guide clip 111 is not of importance as the clip 100 is configured to adjust the position of the blind slats by itself. It is further noted that the clip 100 can be positioned on the blind slat 109A so that it is not engaging the ladder cords 110 when not in use. In this way, the clip 100 does not need to be completely removed from the blind slat 109A when not in use.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A clip for positioning blind slats, comprising:
a clip having an elongated middle section, wherein said middle section comprises an elongated opening for sliding said clip on to a blind slat; and
a pair of arms extending substantially perpendicularly from said middle section, wherein said pair of arms secure ladder cords supporting said blind slat.

2. The clip of claim 1, wherein said pair of arms further comprise protrusions.

3. The clip of claim 1, wherein said pair of arms comprises a first arm and a second arm;
each of said first arm and said second arm comprising a first end and a second end, wherein said first end is attached to said middle section;
said first end having a bend such that each of said first arm and said second arm comprises an L-shape when viewed from the top.

4. The clip of claim 3, wherein said second end of said first arm and said second end of said second arm curve away from each other.

5. The clip of claim 1, wherein said middle section comprises a first end and a second end;
said pair of arms biased toward said second end of said middle section.

6. The clip of claim 2, wherein said protrusions are located on substantial midpoint of said pair of arms.

7. A clip for positioning blind slats, comprising:
a clip having a middle section configured to slide onto a blind slat;
a first arm and a second arm extending from said middle section, wherein said first arm and said second arm are separated by a space;
a protrusion disposed on each of said first arm and said second arm, wherein said protrusion of said first arm and said protrusion of said second arm face each other, further wherein said protrusion is configured to secure ladder cords of said blind slat between said first arm and said second arm.

8. The clip of claim 7, wherein said first arm and said second arm curve away from each other.

9. The clip of claim 7, wherein said middle section comprises a central opening for receiving said blind slat therethrough.

10. The clip of claim 7, wherein said first arm and said second arm are biased toward one end of said middle section.

11. A method of positioning blind slats, comprising the steps of:
(a) providing a clip having a middle section configured to slide onto a blind slat of window blinds, a pair of arms extending from said middle section, wherein said pair of arms are configured to secure ladder cords of said blind slat between said pair of arms;
(b) sliding said clip onto said blind slat such that said clip is substantially aligned with said ladder cords;
(c) guiding said ladder cords between said pair of arms; and
(d) opening or closing said window blinds, wherein a first set of blind slats below said blind set remain in a closed configuration while a second set of blind slats above said blind set can be in an open configuration.

12. The method of claim 11, wherein said clip slides onto said blind slat such that said pair of arms are biased toward a bottom end of said blind slat.

13. The method of claim 11, wherein said pair of arms comprise a first arm and a second arm;
each of said first arm and said second arm comprising a first end and a second end, wherein said first end is attached to said middle section;
said first end having a bend such that each of said first arm and said second arm comprises an L-shape when viewed from the top.

14. The method of claim 11, wherein said second end of said first arm and said second end of said second arm curve away from each other.

15. The method of claim 11, wherein said middle section comprises a first end and a second end;
said pair of arms biased toward said second end of said middle section.

16. The method of claim 11, wherein said pair of arms comprise protrusions located on substantial midpoint of said pair of arms.
